(19) United States
(12) Patent Application Publication
(10) Pub. No.: US 2026/0011068 A1
(43) Pub. Date: Jan. 8, 2026

(54) THREE-DIMENSIONAL VIRTUAL OBJECT GENERATION METHOD AND APPARATUS, AND DEVICE, MEDIUM AND PROGRAM PRODUCT

(71) Applicant: Beijing Zitiao Network Technology Co., Ltd., Haidian District, Beijing (CN)

(72) Inventor: Xinping CUI, Beijing (CN)

(21) Appl. No.: 18/856,239

(22) PCT Filed: Apr. 4, 2023
(86) PCT No.: PCT/CN2023/086198

§ 371 Date: Oct. 11, 2024

(30) Foreign Application Priority Data
Apr. 11, 2022 (CN) 202210374552.3

(51) Int. Cl. G06T 15/04; G06T 15/50

(52) U.S. Cl. CPC G06T 15/04; G06T 15/503; G06T 2210/62

(57) ABSTRACT

The present disclosure relates to a three-dimensional virtual object generation method and apparatus, and a device, a storage medium and a program product. The method includes: receiving a three-dimensional grid model; constructing a height map on the basis of the three-dimensional grid model, wherein the height map refers to a grayscale image that includes height data of a three-dimensional virtual object; processing the height map to obtain a transparency map, a basic color texture image and a roughness map; and fusing the transparency map, the basic color texture image and the roughness map, so as to obtain the three-dimensional virtual object.

### CROSS-REFERENCE TO RELATED APPLICATIONS

This application is a U.S. National Stage Application under 35 U.S.C. 371 of International Patent Application No. PCT/CN2023/086198, filed on Apr. 4, 2023, which is based on and claims the benefit of priority to the Chinese patent application No. 202210374552.3 filed on Apr. 11, 2022, which is hereby incorporated by reference in its into the present application.

### TECHNICAL FIELD

The present disclosure relates to the field of data processing technology, in particular to a three-dimensional virtual object generation method and apparatus, a device, a medium and a program product.

### BACKGROUND

With the market development and the improved aesthetic feeling of the user, the artistic assets such as scenarios and characters made by hand-painted textures cannot meet the aesthetic preference of the user. Designing the artistic works by software becomes the mainstream of the market, and the transformation of project products becomes a trend.

In the related art, the method of producing an artistic work by software is mainly by: first performing high-quality texture sculpture by three-dimensional sculpture software; then producing a low-quality model according to the topology, and baking the normal information of high-quality texture to the low-quality model.

### SUMMARY

In a first aspect, the embodiments of the present disclosure provide a three-dimensional virtual object generation method. The method includes:
receiving a three-dimensional mesh model;
constructing a height map based on the three-dimensional mesh model, wherein the height map refers to a gray scale image including height data of a three-dimensional virtual object;
processing the height map to obtain an Alpha Map, a BaseColor Texture image and a Roughness Map, wherein the Alpha Map refers to a gray scale image including transparency information of the three-dimensional virtual object, the BaseColor Texture image refers to a texture image including base color information of the three-dimensional virtual object, and the Roughness Map refers to a gray scale image including roughness information of the three-dimensional virtual object; and
fusing the Alpha Map, the BaseColor Texture image and the Roughness Map to obtain the three-dimensional virtual object.

In a second aspect, the embodiments of the present disclosure provide a three-dimensional virtual object generation apparatus. The apparatus includes:
a model receiving module configured to receive a three-dimensional mesh model;
a height map constructing module configured to construct a height map based on the three-dimensional mesh model, wherein the height map refers to a gray scale image including height data of a three-dimensional virtual object;
a height map processing module configured to process the height map to obtain an Alpha Map, a BaseColor Texture image and a Roughness Map, wherein the Alpha Map refers to a gray scale image including transparency information of the three-dimensional virtual object, the BaseColor Texture image refers to a texture image including base color information of the three-dimensional virtual object, and the Roughness Map refers to a gray scale image including roughness information of the three-dimensional virtual object; and
a map fusion module configured to fuse the Alpha Map, the BaseColor Texture image and the Roughness Map to obtain the three-dimensional virtual object.

In a third aspect, the embodiments of the present disclosure provide an electronic device. The electronic device includes:
at least one processor;
a memory configured to store at least one program;
when the at least one program is executed by the at least one processor, the at least one processor implements the three-dimensional virtual object generation method according to any of the first aspect described above.

In a fourth aspect, the embodiments of the present disclosure provide a computer-readable storage medium having a computer program stored thereon that, when executed by a processor, implements the three-dimensional virtual object generation method according to any of the first aspect described above.

In a fifth aspect, the embodiments of the present disclosure provide a computer program product. The computer program product includes a computer program or instructions that, when executed by a processor, implement the three-dimensional virtual object generation method according to any of the first aspect described above.

In a sixth aspect, the embodiments of the present disclosure provide a computer program, including: instructions that, when executed by a processor, cause the processor to perform the three-dimensional virtual object generation method according to any of the first aspect described above.

### BRIEF DESCRIPTION OF THE ACCOMPANYING DRAWINGS

The above-described and other features, advantages and aspects of embodiments of the present disclosure will become more apparent in conjunction with the accompanying drawings and with reference to the following detailed description. Throughout the accompanying drawings, the same or similar reference numerals indicate the same or similar elements. It should be understood that the accompanying drawings are schematic, and the members and elements are not necessarily drawn to scale.

FIG. 1 is a flowchart of a three-dimensional virtual object generation method in some embodiments of the present disclosure;

FIG. 2 is a schematic diagram of a three-dimensional mesh model in some embodiments of the present disclosure;

FIG. 3 is a schematic structural diagram of a three-object dimensional virtual generation apparatus in some embodiments of the present disclosure;

FIG. 4 is a schematic structural diagram of an electronic device in some embodiments of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein. Rather, these embodiments are intended for a more thorough and complete understanding of the present disclosure. It should be understood that the accompanying drawings and embodiments of the present disclosure are only for illustrative purposes, rather than for limiting the protection scope of the present disclosure.

It should be understood that the various steps recited in the method embodiments of the present disclosure may be performed according to different sequences, and/or performed in parallel. In addition, the method embodiments may include additional steps and/or omit to perform the illustrated steps. The scope of the present disclosure is not limited in this respect.

As used herein, the term “including” and its variants are open-ended inclusion, that is, “including but not limited to”. The term “based on” means “at least partially based on”. The term “one embodiment” means “at least one embodiment”; the term “another embodiment” means “at least one additional embodiment”; and the term “some embodiments” means “at least some embodiments”. The related definitions of other terms will be given in the following description.

It should be noted that the concepts such as “first” and “second” mentioned in the present disclosure are only used to distinguish different devices, modules or units, but not to limit the order or interdependence of functions performed by these devices, modules or units.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

As mentioned previously, for a method of first performing high-quality texture sculpture and then baking the normal information, the whole process includes many steps and is likely to make mistakes. In case a mistake is made in one of the steps, all subsequent related steps are required to be modified, and the production results cannot be reused.

In order to solve the technical problems above, the embodiments of the present disclosure provide a three-dimensional virtual object generation method and apparatus, a device, a medium and a program product, which shorten the industrial process of producing a virtual object and makes the production process flexible, easily modified and reusable.

The three-dimensional virtual object generation method provided by the embodiments of the present application is introduced below in detail in conjunction with the attached drawings.

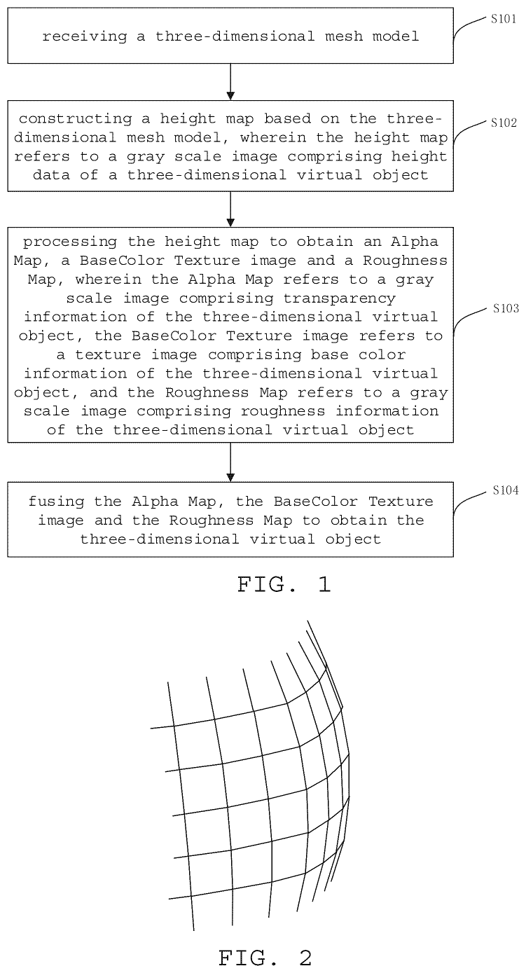

FIG. 1 is a flowchart of a three-dimensional virtual object generation method in some embodiments of the present disclosure. The embodiments may be applied to the circumstance of producing a three-dimensional virtual image. For example, the method may be performed by a three-dimensional virtual object generation apparatus, which may be implemented by software and/or hardware, and which may be configured in an electronic device.

For example, the electronic device may be a mobile terminal, a fixed terminal or a portable terminal, for example, a cell phone, a site, a unit, a device, a multimedia computer, a multimedia tablet, Internet node, a communicator, a desktop computer, a laptop computer, a notebook computer, a netbook computer, a tablet computer, a personal communication system (PCS) device, a personal navigation device, a personal digital assistant (PDA), an audio/video player, a DC/DV, a positioning device, a television receiver, a radio broadcast receiver, an electronic book device, a game device or any combination thereof, including accessories and peripherals of these devices or any combination thereof.

For example, the electronic device may be a server, which may be a physical server or a cloud server, and the server may be one server or a server cluster.

As shown in FIG. 1, the three-dimensional virtual object generation method provided by some embodiments of the present disclosure mainly includes the following steps.

In S101, a three-dimensional mesh model is received.

The three-dimensional mesh model may be understood as a mesh model in three-dimensional. In some embodiments, as shown in FIG. 2, the three-dimensional mesh model may be a mesh with a certain radian.

In the embodiments, the three-dimensional mesh model is generated by mesh generation software, which performs UV tiling on the produced three-dimensional mesh model to obtain the three-dimensional mesh model represented by two-dimensional data and then inputs the three-dimensional mesh model represented by two-dimensional data into the three-dimensional virtual object generation apparatus.

In the embodiments, the received three-dimensional mesh model is a three-dimensional mesh model represented by two-dimensional data after UV tiling.

In S102, a height map is constructed based on the three-dimensional mesh model, wherein the height map refers to a gray scale image including height data of a three-dimensional virtual object.

Height map is generally a gray scale image, and each pixel represents a height of a mesh vertex. Generally, a pixel value 0 (black) represents the lowest point, and a pixel value 255 (white) represents the highest point.

In some embodiments, a plurality of noise maps are created in advance, processed and applied to a three-dimensional mesh model to obtain a height map.

In some embodiments, the noise maps may be set as a built-in node of the three-dimensional virtual object generation apparatus, and the built-in node may be directly called as necessary, so that a height map is obtained after a plurality of processing methods such as fusion, editing and deletion are performed on a plurality of noise maps.

In S103, the height map is processed to obtain an Alpha Map, a BaseColor Texture image and a Roughness Map. The Alpha Map refers to a gray scale image including the transparency information of a three-dimensional virtual object, the BaseColor Texture image refers to a texture image including the base color information of a three-dimensional virtual object, and the Roughness Map refers to a gray scale image including the roughness information of a three-dimensional virtual object.

The transparency information refers to whether a mesh vertex is transparent. The transparency information may be any value between 0 and 1. In response to the transparency being 1, it is indicated that the vertex is opaque, and in response to the transparency being 0, it is indicated that the vertex is transparent.

In the embodiments, the produced virtual object is three-dimensional, thus some vertices among the mesh vertices need be set to be transparent to display the occluded vertices behind the vertices, and to achieve the three-dimensional display effect.

The BaseColor Texture image may be understood as an image with base color and texture. For example, in response to the virtual object to be generated being grassland, the BaseColor Texture image is an image with various green colors overlaid and a certain grass texture.

In the embodiments, the BaseColor Texture image may be selected from texture images set in advance. For example, a plurality of texture images, such as grass texture images, beach texture images and blue sky texture images, are stored in the three-dimensional virtual object generation apparatus in advance, so that the user may directly select similar texture images, which reduces the time for generating virtual objects, and improves the operability of the three-dimensional virtual object generation apparatus.

In some embodiments, dividing the height map into a plurality of regions; setting different base colors for each region; and obtaining a BaseColor Texture image based on base colors of each region and a normal texture image.

In the embodiments, the height map is divided into a plurality of regions according to an actual appearance of the virtual object. In the embodiments, taking an example that the three-dimensional virtual object is a three-dimensional virtual jewelry for explanation, the height map may be divided into a plurality of regions such as a gem region, a petal region, a wing region, a chain region and the like. Different base colors are set for each region. For example, the gem region is set to be dark green, the petal region is set to be brown, and the like.

In the embodiments, another auxiliary map is calculated according to the normal texture image, and fused with base colors of each region to obtain the BaseColor Texture image.

In the embodiments, after the height map is divided into a plurality of regions, different colors are set for each region to obtain a base color image, so that different colors are set for different regions to produce a three-dimensional image with richer colors.

Roughness map is also referred to as roughness degree map. Roughness degree is used to indicate whether the texture is smooth. In three-dimensional computer graphics, a value of black indicates a roughness degree of 0 (smooth), and a value of white indicates a roughness degree of 1 (not smooth). The roughness degree of each vertex in the Roughness Map may be set according to an actual condition of the virtual object.

In some embodiments, processing the BaseColor Texture image to obtain a Roughness Map.

In the embodiments, channel switching may be directly performed on the BaseColor Texture image to switch to the Roughness Map channel and obtain the Roughness Map.

In the embodiments, the Roughness Map is obtained through the BaseColor Texture image by a channel switching method, which avoids the complicated steps of producing the Roughness Map and simplifies the production process of the three-dimensional image.

In S104, the Alpha Map, the BaseColor Texture image and the Roughness Map are fused to obtain a three-dimensional virtual object.

In the embodiments, the Alpha Map, the BaseColor Texture image and the Roughness Map are fused to obtain a three-dimensional virtual image.

The fusion may be direct superposition, or fusion according to preset rules, which will not be specifically limited in the embodiments.

The embodiments of the present disclosure provide a three-dimensional virtual object generation method, which includes: receiving a three-dimensional mesh model; constructing a height map based on the three-dimensional mesh model, wherein the height map refers to a gray scale image including height data of a three-dimensional virtual object; processing the height map to obtain an Alpha Map, a BaseColor Texture image and a Roughness Map, and fusing the Alpha Map, the BaseColor Texture image and the Roughness Map to obtain a three-dimensional virtual object. The technical solution provided by the embodiments of the present disclosure shortens the traditional industrial process of producing a virtual object, and makes the production process flexible, easily modified and reusable.

On the basis of the embodiments above, the embodiments of the present disclosure optimize the embodiments above, and the three-dimensional virtual generation method provided by the embodiments of the present disclosure further includes: processing the height map to obtain a normal texture image, wherein the normal texture image refers to an image with a visual bump effect and the color information; and fusing the normal texture image, the Alpha Map, the BaseColor Texture image and the Roughness Map to obtain a three-dimensional virtual object.

In three-dimensional computer graphics, the normal texture image is a technique to simulate an illuminating effect at a bump, and an implementation of a bump map. The normal texture image may add details to the model without adding polygons. A common scenario in use is to improve the appearance and add details to a low polygon model. The normal texture image is generally generated according to a height map. The normal texture image is usually stored in the form of an ordinary RGB image, wherein the R, G and B components correspond to the X, Y and Z coordinates of the normal respectively.

The process of determining the normal texture image includes: subtracting each pixel of the height map from a pixel above the each pixel to obtain a height difference as a x value of a normal of the each pixel; subtracting each pixel of the height map from a pixel on the right of the each pixel to obtain a height difference as a y value of the normal of the each pixel; and take 1 as a z value of the normal of the each pixel.

In the embodiments, the normal texture image is added to the three-dimensional virtual object, which makes the details of the three-dimensional virtual object richer.

On the basis of the embodiments above, the embodiments of the present disclosure optimize the embodiments above, and the three-dimensional virtual generation method provided by the embodiments of the present disclosure further includes: processing the height map to obtain an Ambient Occlusion Map (AO) map, wherein the AO map refers to a gray scale image including the information of a three-dimensional virtual object occluded by ambient light; and fusing the AO map, the Alpha Map, the BaseColor Texture image and the Roughness Map to obtain a three-dimensional virtual object.

The calculation of the AO map is not affected by any light, wherein only the distance between objects is calculated, and an 8-bit channel is generated according to the distance. In the calculation of the AO map of an object, the program makes each pixel emit a light according to the normal of the object. In response to the light touching an object, feedback is produced so that it is marked that there is an object near here, and a black color is presented. The light emitted by the pixel above does not touch anything, so that it is marked as a white color. In some embodiments, in the AO map, the distance between the planes of the model is simulated.

In the embodiments, the AO map is added to the three-dimensional virtual object, which reflects the influence of light and enriches the details.

On the basis of the above-described embodiments, the embodiments of the present disclosure optimize the embodiments above, and the three-dimensional virtual generation method provided by the embodiments of the present disclosure further includes: processing the height map to obtain a metallic map, which refers to a gray scale image including the metallicity information of a three-dimensional virtual object; and fusing the metallic map, the Alpha Map, the BaseColor Texture image and the Roughness Map to obtain a three-dimensional virtual object.

For example, the metallic map is used to distinguish the insulator and the metal in the map, wherein the value of the metal portion is 1 (white) and the value of the insulator portion is 0 (black). It may be easily understood that, on the height map, the metallic map is black except for the metal material portion. Therefore, in response to a local region of metal being present on the height map, the local region is extracted, and the local metallic map of the local region is calculated, while for the other local region, a black map may be directly determined as the local metallic map of the other local region.

In some embodiments, dividing the height map into a plurality of regions; setting different base colors for each region; determining the metallicity of each region based on base colors of each region to obtain a metallic map.

In the embodiments, the height map is divided into a plurality of regions. For the process of setting different base colors for each region, reference may be made to the description in the embodiments above, which is not specifically described in detail in the embodiments.

In the embodiments, after the height map is divided into a plurality of regions, different colors are set for each region, and the metallicity of each region is determined according to a base color, so as to set different metallicities for different regions, and produce a three-dimensional image with richer metallic colors.

In some embodiments, the metallicity of a region may be determined according to a color of each region. As shown in FIG. 2, in response to the color of the region being yellowish, the metallicity of the region is determined to be 1, and in response to the color of the region being greenish, the metallicity of the region is determined to be 0.

In the embodiments, the metallic map is added to the three-dimensional virtual object, which reflects the glossiness of metal, and allows that the three-dimensional image is more detailed and faithful.

On the basis of embodiments above, a normal texture image, a metallic map, an AO map, an Alpha Map, a BaseColor Texture image and a Roughness Map may be fused to obtain a three-dimensional virtual object. In this way, the obtained three-dimensional virtual object is more detailed and faithful.

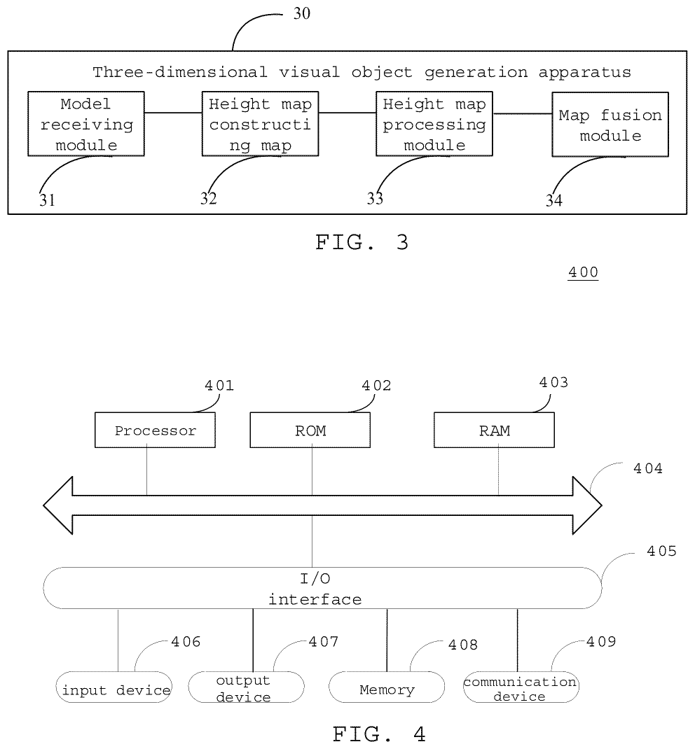

FIG. 3 is a schematic structural diagram of a three-dimensional virtual object generation apparatus in some embodiments of the present disclosure. This embodiment may be applied to the circumstance of producing a three-dimensional virtual image. The three-dimensional virtual object generation apparatus may be implemented by software and/or hardware, and may be configured in an electronic device.

As shown in FIG. 3, the three-dimensional virtual object generation apparatus 30 provided by the embodiment of the present disclosure mainly includes a model receiving module 31, a height map constructing module 32, a height map processing module 33 and a map fusion module 34.

The model receiving module 31 is configured to receive a three-dimensional mesh model.

The height map constructing module 32 is configured to construct a height map based on the three-dimensional mesh model, wherein the height map refers to a gray scale image including height data of a three-dimensional virtual object.

The height map processing module 33 is configured to process the height map to obtain an Alpha Map, a BaseColor Texture image and a Roughness Map, wherein the Alpha Map refers to a gray scale image including the transparency information of a three-dimensional virtual object, the BaseColor Texture refers to a texture image including the base color information of a three-dimensional virtual object, and the Roughness Map refers to a gray scale image including the roughness information of a three-dimensional virtual object.

The map fusion module 34 is configured to fuse the Alpha Map, the BaseColor Texture image and the Roughness Map to obtain a three-dimensional virtual object.

In some embodiments, the height map processing module 33 is further configured to process the height map to obtain a normal texture image, wherein the normal texture image refers to an image with a visual bump effect and the color information; and the map fusion module 34 is also configured to fuse the normal texture image, the Alpha Map, the BaseColor Texture image and the Roughness Map to obtain a three-dimensional virtual object.

In some embodiments, the height map processing module 33 is further configured to process the height map to obtain an AO map obscured by ambient light, wherein the AO map refers to a gray scale image including the information of a three-dimensional virtual object obscured by ambient light; and the map fusion module 34 is further configured to fuse the AO map, the Alpha Map, the BaseColor Texture image and the Roughness Map to obtain a three-dimensional virtual object.

In some embodiments, the height map processing module 33 is further configured to process the height map to obtain a metallic map, wherein the metallic map refers to a gray scale image including the metallicity information of a three-dimensional virtual object; and the map fusion module 34 is also configured to fuse the metallic map, the Alpha Map, the BaseColor Texture image and the Roughness Map to obtain a three-dimensional virtual object.

In some embodiments, the height map processing module 33 is further configured to process the height map to obtain a metallic map, and includes: a region dividing unit for dividing the height map into a plurality of regions; a base color setting unit for setting different base colors for each region; and a metallicity determining unit for determining the metallicity of each region based on base colors of each region so as to obtain a metallic map.

In some embodiments, the height map processing module 33 is configured to process the height map to obtain the BaseColor Texture image, and includes: a region dividing unit for dividing the height map into a plurality of regions; a base color setting unit for setting different base colors for each region; and a BaseColor Texture image determining unit configured to obtain a BaseColor Texture image based on base colors of each region and a normal texture image.

In some embodiments, the height map processing module 33 is configured to process the BaseColor Texture image to obtain a Roughness Map.

The three-dimensional virtual object generation apparatus provided by the embodiments of the present disclosure may perform the steps performed by the three-dimensional virtual object generation method provided by the embodiments of the present disclosure, and the specific performing steps and beneficial effects will not be described in detail here.

FIG. 4 is a schematic structural diagram of an electronic device in some embodiments of the present disclosure. Next, referring to FIG. 4, it shows a structural schematic diagram of an electronic device 400 suitable for implementing the embodiment of the present disclosure. The electronic device 400 in the embodiment of the present disclosure may include, but is not limited to, mobile terminals such as mobile phones, notebook computers, digital broadcast receivers, PDA (personal digital assistant), PAD (pad computer), PMP (Portable Multimedia Player), in-vehicle terminals (for example, in-vehicle navigation terminals) and wearable terminal devices; and fixed terminals such as digital TVs, desktop computers and smart home devices. The terminal device shown in FIG. 4 which is only an example, shall not limit the functions and application range of the embodiments of the present disclosure.

As shown in FIG. 4, the electronic device 400 may include a processor (for example, a central processing unit, a graphic processor, and the like) 401, which may perform various suitable actions and processing according to a program stored in a Read-only Memory (ROM) 402 or a program loaded from a memory 408 into a Random Access Memory (RAM) 403 to implement the image rendering method in an embodiment according to the present disclosure. In the RAM 403, various programs and data required for the operation of the terminal device 400 are also stored. The processor 401, the ROM 402 and the RAM 403 are connected to each other through a bus 404. The input/output (I/O) interface 405 is also connected to the bus 404.

Generally, the following devices may be connected to the I/O interface 405: an input device 406 including, for example, a touch screen, a touch pad, a keyboard, a mouse, a camera, a microphone, an accelerometer, a gyroscope, and the like; an output device 407 including, for example, a Liquid Crystal Display (LCD), a speaker, a vibrator, and the like; a memory 408 including, for example, a magnetic tape, a hard disk, and the like; and a communication device 409. The communication device 409 may allow the terminal device 400 to be in wireless or wired communication with other devices to exchange data. Although FIG. 4 shows the terminal device 400 with various devices, it should be understood that there is no requirement to implement or have all the devices shown. It is possible to alternatively implement or possess more or less devices.

In some embodiments, according to the embodiment of the present disclosure, the process described above with reference to the flow chart may be implemented as a computer software program. For example, in some embodiments of the present disclosure, there includes a computer program product, which includes a computer program carried on a non-transient computer-readable medium, wherein the computer program contains program codes for performing the method shown in the flowchart so as to implement the page jumping method described above. In such embodiments, the computer program may be downloaded and installed from the network through the communication device 409, installed from the memory 408, or installed from the ROM 402. When the computer program is executed by the processor 401, the above-described functions defined in the method of the embodiment of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. Examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, including but not limited to: a wire, an optical cable, radio frequency (RF), and the like, or any suitable combination thereof.

In some embodiments, the client and the server may communicate using any currently known or future developed network protocol such as HTTP (HyperText Transfer Protocol), and may be interconnected with digital data communication in any form or medium (for communication example, network). Examples of communication networks include a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be included in the above-described electronic device; or may also exist alone without being assembled into the electronic device.

The above-described computer-readable medium carries at least one program that, when executed by a terminal device, cause the terminal device to: receive a three-dimensional mesh model; construct a height map based on the three-dimensional mesh model, wherein the height map refers to a gray scale image including height data of a three-dimensional virtual object; process the height map to obtain an Alpha Map, a BaseColor Texture image and a Roughness Map, wherein the Alpha Map refers to a gray scale image including the transparency information of a three-dimensional virtual object, the BaseColor Texture image refers to a texture image including the base color information of a three-dimensional virtual object, and the Roughness Map refers to a gray scale image including the roughness information of a three-dimensional virtual object; and fuse the Alpha Map, the BaseColor Texture image and the Roughness Map to obtain a three-dimensional virtual object.

For example, when the above-described at least one program are executed by the terminal device, the terminal device may also perform other steps according to the above-described embodiments.

The computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (including a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units do not constitute a limitation on the units themselves under certain circumstances.

The functions described hereinabove may be performed at least in part by one or more hardware logic components. For example, without limitation, the hardware logic components a of demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination thereof. Examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides a three-dimensional virtual object generation method, including: receiving a three-dimensional mesh model; constructing a height map based on the three-dimensional mesh model, wherein the height map refers to a gray scale image including height data of a three-dimensional virtual object; processing the height map to obtain an Alpha Map, a BaseColor Texture image and a Roughness Map, wherein the Alpha Map refers to a gray scale image including the transparency information of a three-dimensional virtual object, the BaseColor Texture image refers to a texture image including the base color information of a three-dimensional virtual object, and the Roughness Map refers to a gray scale image including the roughness information of a three-dimensional virtual object; and fusing the Alpha Map, the BaseColor Texture image and the Roughness Map to obtain a three-dimensional virtual object.

According to one or more embodiments of the present disclosure, the present disclosure provides a three-dimensional virtual object generation method, wherein the method further includes: processing the height map to obtain a normal texture image, wherein the normal texture image refers to an image with a visual bump effect and the color information; and fusing the normal texture image, the Alpha Map, the BaseColor Texture image and the Roughness Map to obtain a three-dimensional virtual object.

According to one or more embodiments of the present disclosure, the present disclosure provides a three-dimensional virtual object generation method, wherein the method further includes: processing the height map to obtain an AO map, wherein the AO map refers to a gray scale image including the occlusion information by ambient light of a three-dimensional virtual object; and fusing the AO map, the Alpha Map, the BaseColor Texture image and the Roughness Map to obtain a three-dimensional virtual object.

According to one or more the present disclosure, the present disclosure provides a three-dimensional virtual object generation method, wherein the method further includes: processing the height map to obtain a metallic map, wherein the metallic map refers to a gray scale image including the metallicity information of a three-dimensional virtual object; and fusing the metallic map, the Alpha Map, the BaseColor Texture image and the Roughness Map to obtain a three-dimensional virtual object.

According to one or more embodiments of the present disclosure, the present disclosure provides a three-dimensional virtual object generation method, wherein the step of processing the height map to obtain a metallic map includes: dividing the height map into a plurality of regions; setting different base colors for each region; and determining the metallicity of each region based on base colors of each region so as to obtain a metallic map.

According to one or more embodiments of the present disclosure, the present disclosure provides a three-dimensional virtual object generation method, wherein the step of processing the height map to obtain a BaseColor Texture image includes: dividing the height map into a plurality of regions; setting different base colors for each region; and obtaining a BaseColor Texture image based on base colors of each region and a normal texture image.

According to one or more embodiments of the present disclosure, the present disclosure provides a three-dimensional virtual object generation method, wherein the step of processing the height map to obtain a Roughness Map includes: processing the BaseColor Texture image to obtain a Roughness Map.

In some embodiments, the step of processing the height map to obtain a Roughness Map includes: performing channel switching on the BaseColor Texture image to obtain the Roughness Map.

In some embodiments, the step of obtaining a BaseColor Texture image based on base colors of each region and a normal texture image includes: calculating an auxiliary map according to the normal texture image; and fusing the auxiliary map with base colors of each region to obtain the BaseColor Texture image.

In some embodiments, the step of processing the height map to obtain a normal texture image includes: calculating a height difference between a pixel on the height map and another pixel located on an upper side of the pixel as an x coordinate value of a normal of the pixel; and calculating a height difference between the pixel on the height map and another pixel located on a right side of the pixel as a y coordinate value of a normal of the pixel.

According to one or more embodiments of the present disclosure, the present disclosure provides a three-dimensional virtual object generation apparatus, including: a model receiving module configured to receive a three-dimensional mesh model; a height map constructing module configured to construct a height map based on the three-dimensional mesh model, wherein the height map refers to a gray scale image including height data of a three-dimensional virtual object; a height map processing module configured to process the height map to obtain an Alpha Map, a BaseColor Texture image and a Roughness Map, wherein the Alpha Map refers to a gray scale image including the transparency information of a three-dimensional virtual object, the BaseColor Texture refers to a texture image including the base color information of a three-dimensional virtual object, and the Roughness Map refers to a gray scale image including the roughness information of a three-dimensional virtual object; and a map fusion module configured to fuse the Alpha Map, the BaseColor Texture image and the Roughness Map to obtain a three-dimensional virtual object.

According to one or more embodiments of the present disclosure, the present disclosure provides a three-dimensional virtual object generation apparatus, wherein the height map processing module is further configured to process the height map to obtain a normal texture image, wherein the normal texture image refers to an image with a visual bump effect and the color information; and the map fusion module is further configured to fuse the normal texture image, the Alpha Map, the BaseColor Texture image and the Roughness Map to obtain a three-dimensional virtual object.

According to one or more embodiments of the present disclosure, the present disclosure provides a three-dimensional virtual object generation apparatus, wherein the height map processing module is further configured to process the height map to obtain an AO map, wherein the AO map refers to a gray scale image including the occlusion information by ambient light of a three-dimensional virtual object; and the map fusion module is also configured to fuse the AO map, the Alpha Map, the BaseColor Texture image and the Roughness Map to obtain a three-dimensional virtual object.

According to one or more embodiments of the present disclosure, the present disclosure provides a three-dimensional virtual object generation apparatus, wherein the height map processing module is further configured to process the height map to obtain a metallic map, wherein the metallic map refers to a gray scale image including the metallicity information of a three-dimensional virtual object; and the map fusion module is also configured to fuse the metallic map, the Alpha Map, the BaseColor Texture image and the Roughness Map to obtain a three-dimensional virtual object.

According to one or more embodiments of the present disclosure, the present disclosure provides a three-dimensional virtual object generation apparatus, wherein the height map processing module is further configured to process the height map to obtain a metallic map, and includes: a region dividing unit for dividing the height map into a plurality of regions; a base color setting unit for setting different base colors for each region; and a metallicity determining unit for determining the metallicity of each region based on base colors of each region so as to obtain a metallic map.

According to one or more embodiments of the present disclosure, the present disclosure provides a three-dimensional virtual object generation apparatus, wherein the height map processing module is configured to process the height map to obtain the BaseColor Texture image, and includes: a region dividing unit for dividing the height map into a plurality of regions; a base color setting unit for setting different base colors for each region; and a BaseColor Texture image determining unit configured to obtain a BaseColor Texture image based on base colors of each region and a normal texture image.

According to one or more embodiments of the present disclosure, the present disclosure provides a three-dimensional virtual object generation apparatus, wherein the height map processing module is configured to process the BaseColor Texture image to obtain a Roughness Map.

According to one or more embodiments of the present disclosure, the present disclosure provides an electronic device, including:
at least one processor;
a memory for storing at least one program;
when the at least one program is executed by the at least one processor, the at least one processor is caused to implement the three-dimensional virtual object generation method provided by any of the present disclosure.

According to one or more embodiments of the present disclosure, the present disclosure provides a computer-readable storage medium having a computer program stored thereon that, when executed by a processor, implements any of the three-dimensional virtual object generation methods provided by the present disclosure.

The embodiment of the present disclosure also provides a computer program product, including a computer program or instructions that, when executed by a processor, implement the three-dimensional virtual object generation method as described above.

The embodiments of the present disclosure also provide a computer program, including: instructions that, when executed by a processor, cause the processor to perform the three-dimensional virtual object generation method according to any of the embodiments of the present disclosure.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

1. A three-dimensional virtual object generation method, comprising:
receiving a three-dimensional mesh model;
constructing a height map based on the three-dimensional mesh model, wherein the height map refers to a gray scale image comprising height data of a three-dimensional virtual object;
processing the height map to obtain an Alpha Map, a BaseColor Texture image and a Roughness Map, wherein the Alpha Map refers to a gray scale image comprising transparency information of the three-dimensional virtual object, the BaseColor Texture image refers to a texture image comprising base color information of the three-dimensional virtual object, and the Roughness Map refers to a gray scale image comprising roughness information of the three-dimensional virtual object; and
fusing the Alpha Map, the BaseColor Texture image and the Roughness Map to obtain the three-dimensional virtual object.

2. The three-dimensional virtual object generation method according to claim 1, further comprising:
processing the height map to obtain a normal texture image, wherein the normal texture image refers to an image with a visual bump effect and color information; and
fusing the normal texture image, the Alpha Map, the BaseColor Texture image and the Roughness Map to obtain the three-dimensional virtual object.

3. The three-dimensional virtual object generation method according to claim 1, further comprising:
processing the height map to obtain an Ambient Occlusion (AO) map, wherein the AO map refer to a gray scale image comprising occlusion information by ambient light of the three-dimensional virtual object; and
fusing the AO map, the Alpha Map, the BaseColor Texture image and the Roughness Map to obtain the three-dimensional virtual object.

4. The three-dimensional virtual object generation method according to claim 1, further comprising:
processing the height map to obtain a metallic map, wherein the metallic map refers to a gray scale image comprising metallicity information of the three-dimensional virtual object; and
fusing the metallic map, the Alpha Map, the BaseColor Texture image and the Roughness Map to obtain the three-dimensional virtual object.

5. The three-dimensional virtual object generation method according to claim 4, wherein the processing the height map to obtain the metallic map comprises:
dividing the height map into a plurality of regions;
setting different base colors for each region; and
determining metallicity of the each region based on base colors of the each region to obtain the metallic map.

6. The three-dimensional virtual object generation method according to claim 1, wherein the processing the height map to obtain the BaseColor Texture image comprises:
dividing the height map into a plurality of regions;
setting different base colors for each region; and
obtaining the BaseColor Texture image based on base colors of the each region and a normal texture image.

7. The three-dimensional virtual object generation method according to claim 1, wherein the processing the height map to obtain the Roughness Map comprises:
processing the BaseColor Texture image to obtain a Roughness Map.

8. The three-dimensional virtual object generation method according to claim 1, wherein the processing the height map to obtain the Roughness Map comprises:
performing a channel switching on the BaseColor Texture image to obtain the Roughness Map.

9. The three-dimensional virtual object generation method according to claim 6, wherein the obtaining the BaseColor Texture image based on the base colors of the each region and the normal texture image comprises:
calculating an auxiliary map according to the normal texture image; and
fusing the auxiliary map with the base colors of the each region to obtain the BaseColor Texture image.

10. The three-dimensional virtual object generation method according to claim 2, wherein the processing the height map to obtain the normal texture image comprises:
calculating a height difference between a pixel on the height map and another pixel located on an upper side of the pixel as an x coordinate value of a normal of the pixel; and
calculating a height difference between the pixel on the height map and another pixel located on a right side of the pixel as a y coordinate value of the normal of the pixel.

11. (canceled)

12. An electronic device comprising:
at least one processor;
a memory configured to store at least one program;
when the at least one program is executed by the at least one processor, the at least one processor implements a three-dimensional virtual object generation method, comprising:
receiving a three-dimensional mesh model;
constructing a height map based on the three-dimensional mesh model, wherein the height map refers to a gray scale image comprising height data of a three-dimensional virtual object;
processing the height map to obtain an Alpha Map, a BaseColor Texture image and a Roughness Map, wherein the Alpha Map refers to a gray scale image comprising transparency information of the three-dimensional virtual object, the BaseColor Texture image refers to a texture image comprising base color information of the three-dimensional virtual object, and the Roughness Map refers to a gray scale image comprising roughness information of the three-dimensional virtual object; and
fusing the Alpha Map, the BaseColor Texture image and the Roughness Map to obtain the three-dimensional virtual object.

13. A non-transitory_computer-readable storage medium having a computer program stored thereon that, when executed by a processor, implements a three-dimensional virtual object generation method, comprising:
receiving a three-dimensional mesh model;
constructing a height map based on the three-dimensional mesh model, wherein the height map refers to a gray scale image comprising height data of a three-dimensional virtual object;
processing the height map to obtain an Alpha Map, a BaseColor Texture image and a Roughness Map, wherein the Alpha Map refers to a gray scale image comprising transparency information of the three-dimensional virtual object, the BaseColor Texture image refers to a texture image comprising base color information of the three-dimensional virtual object, and the Roughness Map refers to a gray scale image comprising roughness information of the three-dimensional virtual object; and
fusing the Alpha Map, the BaseColor Texture image and the Roughness Map to obtain the three-dimensional virtual object.

14-15. (canceled)

16. The three-dimensional virtual object generation device according to claim 12, wherein the at least one processor implements following steps:
processing the height map to obtain a normal texture image, wherein the normal texture image refers to an image with a visual bump effect and color information; and
fusing the normal texture image, the Alpha Map, the BaseColor Texture image and the Roughness Map to obtain the three-dimensional virtual object.

17. The three-dimensional virtual object generation device according to claim 12, wherein the at least one processor implements following steps:
processing the height map to obtain an Ambient Occlusion (AO) map, wherein the AO map refer to a gray scale image comprising occlusion information by ambient light of the three-dimensional virtual object; and
fusing the AO map, the Alpha Map, the BaseColor Texture image and the Roughness Map to obtain the three-dimensional virtual object.

18. The three-dimensional virtual object generation device according to claim 12, wherein the at least one processor implements following steps:
processing the height map to obtain a metallic map, wherein the metallic map refers to a gray scale image comprising metallicity information of the three-dimensional virtual object; and
fusing the metallic map, the Alpha Map, the BaseColor Texture image and the Roughness Map to obtain the three-dimensional virtual object.

19. The three-dimensional virtual object generation device according to claim 12, wherein the at least one processor implements following steps:
processing the height map to obtain a metallic map, wherein the metallic map refers to a gray scale image comprising metallicity information of the three-dimensional virtual object; and
fusing the metallic map, the Alpha Map, the BaseColor Texture image and the Roughness Map to obtain the three-dimensional virtual object.

20. The three-dimensional virtual object generation device according to claim 19, wherein the at least one processor implements following steps:
dividing the height map into a plurality of regions;
setting different base colors for each region; and
determining metallicity of the each region based on base colors of the each region to obtain the metallic map.

21. The three-dimensional virtual object generation device according to claim 12, wherein the at least one processor implements following steps:
dividing the height map into a plurality of regions;
setting different base colors for each region; and
obtaining the BaseColor Texture image based on base colors of the each region and a normal texture image.

22. The three-dimensional virtual object generation device according to claim 12, wherein the at least one processor implements following steps:
processing the BaseColor Texture image to obtain a Roughness Map.

23. The three-dimensional virtual object generation device according to claim 12, wherein the at least one processor implements following steps:
performing a channel switching on the BaseColor Texture image to obtain the Roughness Map.
